(19) United States
(12) Patent Application Publication
(10) Pub. No.: US 2017/0295017 A1
(43) Pub. Date: Oct. 12, 2017

(54) SYSTEM AND METHOD FOR MOBILE CROSS-AUTHENTICATION

(71) Applicants: Seung Eun HONG, Seoul (KR); Paul HONG, Seoul (KR)

(72) Inventors: Seung Eun HONG, Seoul (KR); Paul HONG, Seoul (KR)

(21) Appl. No.: 15/521,748

(22) PCT Filed: Oct. 13, 2015
(86) PCT No.: PCT/KR2015/010762

§ 371 Date: Apr. 25, 2017

(30) Foreign Application Priority Data
Oct. 25, 2014 (KR) 10-2014-0145593

(51) Int. Cl. H04L 9/32; H04W 12/06; G06Q 20/32

(52) U.S. Cl. CPC H04L 9/32; G06Q 20/3226; H04W 12/06

(57) ABSTRACT

The present invention relates to a system and a method for mobile cross-authentication comprising: generating an online authentication code (Ocode) and a mobile authentication code (Mcode) from an authentication server when performing online authentication, providing the online authentication code (Ocode) and the mobile authentication code (Mcode) to a computer terminal and a mobile terminal of the user respectively, receiving and verifying the online authentication code and the mobile authentication code received by the computer terminal and the mobile terminal to the authentication server through the mobile terminal and the computer terminal respectively.

### TECHNICAL FIELD

The present invention relates to a user authentication system and method for login and financial transactions such as payment settlement, stock trading, and transfers, and more particularly, to a mobile cross-authentication system and method for performing mutual authentication during online authentication, in which an authentication server generates an online authentication code (Ocode) and a mobile authentication code (Mcode), the online authentication code (Ocode) is provided to a user's computer terminal, the mobile authentication code (Mcode) is provided to a user's portable terminal, the online authentication code (Ocode) received by the user's computer terminal is input into the user's portable terminal to be transmitted to the authentication server, and the mobile authentication code (Mcode) received by the user's portable terminal is input into the user's computer terminal to be transmitted to the authentication server.

### BACKGROUND ART

As the Internet becomes popular and general, people are receiving various services through the Internet. People purchase products through e-commerce, use Internet banking such as an account transfer, and access various websites to receive information.

As described above, in order to have various online services, people are accustomed to a method of inputting and storing personal information and financial information through the Internet. Financial fraudsters are exploiting the above method so that important personal information is hacked and leaked, thereby causing mental and financial damage to people.

In order to prevent such personal information leakage and financial fraud, authentication techniques, in which digital signature authentication based on an accredited certificate, a one-time password (OTP), mobile phone authentication, automatic response system (ARS) authentication, or the like is added to or combined with a technique using identification (ID) and a password, have been applied basically.

However, a digital signature authentication technique has been threatened with security thereof due to a leakage and theft of an accredited certificate, and in order to solve this problem, although a technique of safely storing an accredited certificate using a security token or a universal subscriber identity module (USIM) is disclosed in the prior laid-open patent documentation 10-2012-0100342 and the prior laid-open patent documentation 10-2012-0071945, there has been a problem in that the burden of using a separate hardware device is increased and the techniques have to be dependent on a specific hardware module.

In addition, due to the emergence of hacking techniques such as memory hacking, the financial authentication methods that use accredited certificates and OTP devices have also become ineffective against financial fraud, resulting in financial fraud and social problems.

Financial fraud or the like occurs in existing mobile phone authentication methods due to steal of a short message service (SMS) authentication code such as swishing, and even in the case of existing ARS authentication, problems caused by call forwarding have been revealed and a security threat is posed.

In addition, although a virtual card number is provided in the case of app card methods, because there is a limitation in that an application has to be downloaded to a smart phone, usability of the app card methods is lowered, and the app card methods cannot be applied as an authentication method of a user using a general mobile phone.

### Technical Problem

The present invention relates to a user authentication system and method for login and financial transactions such as payment settlement, stock trading, and transfers, and more particularly, to a mobile cross-authentication system and method capable of performing authentication during online authentication, in which an authentication server generates an online authentication code (Ocode) and a mobile authentication code (Mcode), the online authentication code (Ocode) is provided to a user's computer terminal, the mobile authentication code (Mcode) is provided to a user's portable terminal, the online authentication code (Ocode) received by the user's computer terminal is input into the user's portable terminal to be transmitted to the authentication server, the mobile authentication code (Mcode) received by the user's portable terminal is input into the user's computer terminal to be transmitted to the authentication server, and thereby a separate smart phone application and a specific hardware module are not needed and authentication is safely performed without theft even when an authentication code is stolen.

### Technical Solution

One aspect of the present invention provides a mobile cross-authentication system including: a computer terminal which transmits a signal of an authentication request to a authentication server when using an arbitrary service configured to need online authentication, transmits and inputs user's portable terminal identification information (Tel_no) into the authentication server when the authentication server requests the user's portable terminal identification information, receives an online authentication code (Ocode) generated in the authentication server by the authentication request, displays the online authentication code (Ocode) thereon, receives a mobile authentication code (Mcode) which is generated in the authentication server by the authentication request and received from the portable terminal, transmits the mobile authentication code (Mcode) to the authentication server, and displays an authentication result received from the authentication server thereon; a portable terminal which receives the mobile authentication code (Mcode) generated in the authentication server by the authentication request, displays the mobile authentication code (Mcode) thereon, and receives the online authentication code (Ocode) displayed on the computer terminal to transmit the online authentication code (Ocode) to the authentication server; and an authentication server which receives the signal of the authentication request from the computer terminal, requests the user's portable terminal identification information to the computer terminal, receives the portable terminal identification information (Tel_no) input from the computer terminal in response to the request, generates the online authentication code (Ocode) and the mobile authentication code (Mcode) which are respectively provided to the computer terminal and the portable terminal, obtains a mobile authentication code (Mcode*) input and received from the computer terminal, obtains an online authentication code (Ocode*) input and received from the portable terminal, obtains a portable terminal identification information (Dev_no) when received the online authentication code (Ocode*), compares the obtained online authentication code (Ocode*) with the online authentication code (Ocode) generated by the authentication request and the obtained mobile authentication code (Mcode*) with the mobile authentication code (Mcode) generated by the authentication request to verify accordance therebetween, compares the obtained portable terminal identification information (Dev_no) with the portable terminal identification information (Tel_no) input from the computer terminal to verify accordance therebetween, and transmits an authentication result according to the verifications to the computer terminal.

Here, Mcode* and Ocode* refer to information of a case in which an online authentication code and a mobile authentication code are transmitted and provided from an authentication server to one device, and input back from the other device

The authentication server may include: an authentication request receiver which receives the signal of the authentication request from the computer terminal, requests the user's portable terminal identification information to the computer terminal, and receives the portable terminal identification information (Tel_no) input from the computer terminal in response to the request; an authentication code generator which generates the online authentication code (Ocode) and the mobile authentication code (Mcode) by the authentication request; an online authentication code provider which provides the online authentication code (Ocode) generated by the authentication code generator to the computer terminal; a mobile authentication code provider which provides the mobile authentication code (Mcode) generated by the authentication code generator to the portable terminal; a mobile authentication code obtainer which obtains a mobile authentication code (Mcode*) received from the computer terminal by being input the mobile authentication code (Mcode) displayed on the portable terminal into the computer terminal; an online authentication code obtainer which obtains an online authentication code (Ocode*) received from the portable terminal by being input the online authentication code (Ocode) displayed on the computer terminal into the portable terminal; a portable terminal identification information obtainer which detects and obtains the portable terminal identification information (Dev_no) when received the online authentication code (Ocode*); an authentication verifier which compares the obtained online authentication code (Ocode*) with the online authentication code (Ocode) generated by the authentication code generator and the obtained mobile authentication code (Mcode*) with the mobile authentication code (Mcode) generated by the authentication code generator to verify accordance therebetween, and compares the obtained portable terminal identification information (Dev_no) with the portable terminal identification information (Tel_no) input from the computer terminal to verify accordance therebetween; and an authentication result transmitter which transmits an authentication result according to the verifications to the computer terminal.

The authentication code generator may include an online authentication code generator configured to generate the online authentication code (Ocode) and a mobile authentication code generator configured to generate the mobile authentication code (Mcode), wherein the online authentication code (Ocode) and the mobile authentication code (Mcode) may be generated as one-time random authentication codes and deleted when the online authentication code (Ocode) and the mobile authentication code (Mcode) are unused within a predetermined period from a generated time point thereof.

The authentication verifier may compare the online authentication code (Ocode) generated by the authentication request with the online authentication code (Ocode*) received from the portable terminal to verify accordance therebetween, compare the mobile authentication code (Mcode) generated by the authentication request with the mobile authentication code (Mcode*) received from the computer terminal to verify accordance therebetween, and compare the portable terminal identification information (Tel_no) input from the computer terminal with the portable terminal identification information (Dev_no) detected and obtained when received the online authentication code (Ocode*) to verify accordance therebetween, and a result according to the authentication request may be determined as authentication success when all the three verifications succeed and be determined as authentication fail even when one of the three verifications fails.

The computer terminal may include: an authentication requester which transmits the signal of the authentication request to the authentication server and transmits the portable terminal identification information (Tel_no) to the authentication server by the request of the portable terminal identification information; an online authentication code receiver which receives the online authentication code (Ocode) generated in the authentication server by the authentication request; an online authentication code displayer which displays the online authentication code (Ocode) received from the authentication server on a screen of the computer terminal; an mobile authentication code inputter which inputs the mobile authentication code (Mcode), which is generated in the authentication server by the authentication request and received from the portable terminal, into the computer terminal; a mobile authentication code transmitter which transmits the input mobile authentication code (Mcode) to the authentication server; and an authentication result displayer which displays an authentication result received from the authentication server after the authentication server performs verification.

When an arbitrary service configured to need authentication is used, the computer terminal may be configured to directly request the authentication to the authentication server, may further include a payment gateway (PG) server to be configured to request the authentication to the authentication server through the PG server when the computer terminal requests payment to the PG server, and may also further include a service server (the service server provides services for login, an account transfer, e-commerce, etc.) to be configured to request the authentication to the authentication server through the service server when the computer terminal requests performing a service to the service server.

The portable terminal may include: a mobile authentication code receiver which receives the mobile authentication code (Mcode) generated in the authentication server by the authentication request; a mobile authentication code displayer which displays the mobile authentication code (Mcode) received from the authentication server on a screen of the portable terminal; an online authentication code inputter which inputs the online authentication code (Ocode) displayed on the computer terminal into the portable terminal; and an online authentication code transmitter which transmits the input online authentication code (Ocode) to the authentication server.

The portable terminal may receive a message including the mobile authentication code (Mcode) generated by the authentication server, receive the online authentication code (Ocode) displayed on the computer terminal, form a message, and transmit the formed message to the authentication server, and the formed message may be formed as one of mobile communication messages, such as a short message service (SMS) message, a long message service (LMS) message, and a multimedia message service (MMS) message, and smart phone push messages.

Another aspect of the present invention provides a mobile cross-authentication method including: an authentication request process in which a computer terminal transmits a signal of an authentication request to an authentication server when using an arbitrary service configured to need online authentication, receives a request of user's portable terminal identification information from the authentication server, and transmits a user's portable terminal identification information (Tel_no) to the authentication server in response to the request; an authentication code generation process in which the authentication server generates an online authentication code (Ocode) and a mobile authentication code (Mcode) by the authentication request; an authentication code provision process in which the authentication server provides the online authentication code (Ocode) generated by the authentication request to the computer terminal and provides the mobile authentication code (Mcode) generated by the authentication request to the portable terminal; an authentication code display process in which the computer terminal displays the online authentication code (Ocode) received from the authentication server on a screen of the computer terminal, and the portable terminal displays the mobile authentication code (Mcode) received from the authentication server on a screen of the portable termical; an authentication code cross-transmission process in which the computer terminal receives the mobile authentication code (Mcode) displayed on the portable terminal and transmits the mobile authentication code (Mcode) to the authentication server, and the portable terminal receives the online authentication code (Ocode) displayed on the computer terminal and transmits the online authentication code (Ocode) to the authentication server; and an authentication verification process in which the authentication server obtains a mobile authentication code (Mcode*) received from the computer terminal, obtains an online authentication code (Ocode*) received from the portable terminal, detects and obtains a portable terminal identification information (Dev_no) when received the online authentication code (Ocode*), compares the obtained online authentication code (Ocode*) with the online authentication code (Ocode) generated by the authentication request and the obtained mobile authentication code (Mcode*) with the mobile authentication code (Mcode) generated by the authentication request to verify accordance therebetween, compares the obtained portable terminal identification information (Dev_no) with the portable terminal identification information (Tel_no) input from the computer terminal to verify accordance therebetween, and transmits an authentication result according to the verifications to the computer terminal.

The authentication code generation process may include: an online authentication code generation process in which the authentication server generates the online authentication code (Ocode); and a mobile authentication code generation process in which the authentication server generates the mobile authentication code (Mcode).

The authentication code provision process may include: an online authentication code provision process in which the authentication server provides the online authentication code (Ocode) generated during the authentication code generation process to the computer terminal; and a mobile authentication code provision process in which the authentication server provides the mobile authentication code (Mcode) generated during the authentication code generation process to the portable terminal.

The authentication code display process may include: an online authentication code display process in which the computer terminal displays the online authentication code (Ocode) received from the authentication server on the screen of the computer terminal; and a mobile authentication code display process in which the portable terminal displays the mobile authentication code (Mcode) received from the authentication server to the screen of the portable terminal.

The authentication code cross-transmission process may include: an online authentication code transmission process in which the portable terminal receives the online authentication code (Ocode) displayed on the computer terminal and transmits the online authentication code (Ocode) to the authentication server; and a mobile authentication code transmission process in which the computer terminal receives the mobile authentication code (Mcode) displayed on the portable terminal and transmits the mobile authentication code (Mcode) to the authentication server.

The authentication verification process may include: a portable terminal identification information obtainment process which detects and obtains the portable terminal identification information (Dev_no) when received the online authentication code (Ocode*) from the portable terminal; a verification performance process which compares the obtained online authentication code (Ocode*) with the online authentication code (Ocode) generated by the authentication request and the obtained mobile authentication code (Mcode*) with the mobile authentication code (Mcode) generated by the authentication request to verify accordance therebetween and compares the obtained portable terminal identification information (Dev_no) with the portable terminal identification information (Tel_no) input from the computer terminal to verify accordance therebetween; and an authentication result notification process which transmits an authentication result according to the verification to the computer terminal.

### Advantageous Effects

Since authentication is performed by generating an online authentication code (Ocode) and a mobile authentication code (Mcode) in an authentication server, providing the online authentication code (Ocode) to a user's computer terminal, providing the mobile authentication code (Mcode) to a user's portable terminal, inputting the online authentication code (Ocode) received by the user's computer terminal into the user's portable terminal to be transmitted to the authentication server, and inputting the mobile authentication code (Mcode) received by the user's portable terminal into the user's computer terminal to be transmitted to the authentication server, the present invention is advantageous for maintaining two times of mutual security and preventing authentication code theft by a third person because portable terminal authentication using user's portable terminal identification information (Tel_no) is performed even when an authentication code is leaked or stolen.

In addition, since an online authentication code (Ocode) and a mobile authentication code (Mcode) according to the present invention are generated as one-time random authentication codes, security can be improved because the online authentication code (Ocode) and the mobile authentication code (Mcode) are deleted when the online authentication code (Ocode) and the mobile authentication code (Mcode) are unused within a predetermined period from a generated time point thereof.

In addition, the present invention does not depend on a separate hardware module such as a hardware security token, a universal subscriber identity module (USIM), and a micro SD by performing authentication only using an online authentication code (Ocode) and a mobile authentication code (Mcode), and is advantageous for improving usability because the present invention can be applied to both a smart device and a general mobile phone using a mobile communication message and a push message that use a method of transmitting and receiving a message including an authentication code between an authentication server and a user's portable terminal.

In addition, since the present invention includes various services configured to need online authentication and can thus be equally applied to various cases such as login, member registration, payment settlement, an account transfer, e-commerce, etc., the present invention is advantageous for having a safe and convenient authentication method.

### DESCRIPTION OF DRAWINGS

FIG. 1 is a schematic view illustrating a configuration of a mobile cross-authentication system according to the present invention.

FIG. 2 is a view illustrating a detailed configuration of the mobile cross-authentication system according to the present invention.

FIG. 3 is a procedure flowchart illustrating a mobile cross-authentication method according to a first embodiment of the present invention.

FIG. 4 is a procedure flowchart illustrating a mobile cross-authentication method according to a second embodiment of the present invention.

FIG. 5 is a procedure flowchart illustrating a mobile cross-authentication method according to a third embodiment of the present invention.

FIG. 6 is a flowchart illustrating an authentication verification method in an authentication server to which the mobile cross-authentication method according to the present invention is applied.

### MODES OF THE INVENTION

Hereinafter, a configuration and operation of a mobile cross-authentication system according to the present invention and an authentication method of the system will be described with reference to the accompanying drawings.

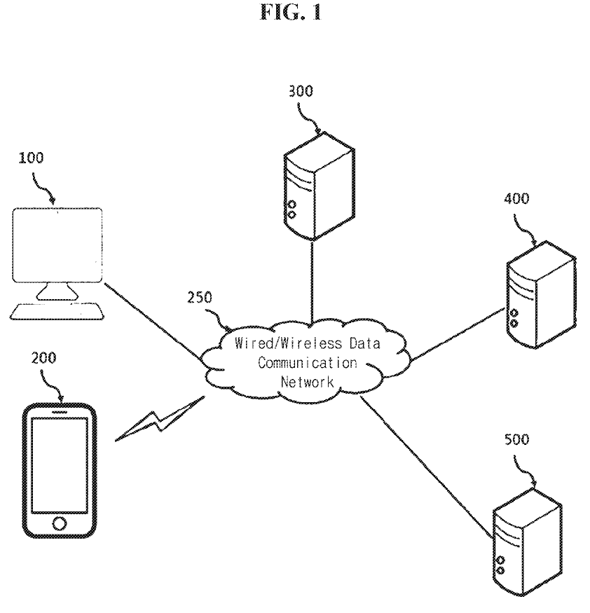

FIG. 1 is a schematic view illustrating a configuration of a mobile cross-authentication system according to the present invention.

Referring to FIG. 1, a mobile cross authentication system according to the present invention may include a user's computer terminal 100, a user's portable terminal 200, and an authentication server 300 and may further include a payment gateway (PG) server 400 and a service server 500.

The computer terminal 100, the portable terminal 200, the authentication server 300, the PG server 400, and the service server 500 are connected through a wired/wireless data communication network 250 to perform data communication.

The wired/wireless data communication network 250 is a communication network including a mobile communication network capable of performing data communication including a 2nd generation (2G), a 3rd generation (3G), a 4th generation (4G), or the like and an Internet network in which a wireless fidelity (WiFi) network, a wide area network (WAN), a local area network (LAN), etc. are combined with each other.

The computer terminal 100 may be a notebook computer, a personal computer (PC), a desktop computer, a tablet PC, or the like or may be a smart device such as a smart phone, a smart pad, etc. When the computer terminal 100 is a smart device such as a smart phone or a smart pad, the computer terminal 100 may be a portable terminal 200. That is, when a user requests performing authentication through the smart device, one terminal may be used for either the computer terminal 100 or the portable terminal 200.

A computer terminal 100 according to a first embodiment of the present invention transmits a signal of an authentication request through the wired/wireless data communication network 250 to the authentication server 300, receives a request of user's portable terminal identification information from the authentication server, transmits user's portable terminal identification information Tel_no to the authentication server, displays an online authentication code Ocode generated by the authentication server 300 on the computer terminal 100, receives a mobile authentication code Mcode displayed on the portable terminal 200, transmits the mobile authentication code Mcode to the authentication server 300, performs verification in the authentication server 300, receives an authentication result according to the verification, and displays the authentication result thereon.

When an arbitrary service configured to need online authentication is used, the authentication system may be configured so that the computer terminal 100 directly requests authentication to the authentication server 300, may be configured to further include a PG server 400 so that authentication is requested to the authentication server 300 through the PG server 400 when the computer terminal 100 requests payment to the PG server 400, and may be configured to further include a service server 500 so that authentication is requested to the authentication server through the service server 500 when the computer terminal 100 requests performing a service to the service server 500.

The portable terminal 200 is a terminal having inherent identification information (portable terminal identification information such as telephone numbers, etc.), and may be a device such as a general portable phone, a smart phone, a smart pad, etc., is connected to the wired/wireless data communication network 250, and transmits or receives a message including an authentication code to or from the authentication server 300.

The portable terminal 200 receives the mobile authentication code Mcode generated in the authentication server 300 by the authentication request and displays the mobile authentication code Mcode on a screen of the portable terminal 200, receives the online authentication code Ocode displayed on the computer terminal 100, transmits the online authentication code Ocode to the authentication server 300, receives an authentication result from the authentication server 300, and displays the authentication result thereon.

The portable terminal 200 receives a message including the mobile authentication code Mcode generated by the authentication server 300, receives the online authentication code Ocode displayed on the computer terminal 100, forms a message, and transmits the formed message to the authentication server 300, and the formed message may be configured as one of mobile communication messages, such as a short message service (SMS) message, a long message service (LMS) message, a multimedia message service (MMS) message, etc., and smart phone push messages.

After the authentication server 300 receives the signal of the authentication request from the computer terminal 100, the authentication server 300 requests user's portable terminal identification information to the computer terminal 100, receives user's portable terminal identification information Tel_no input by the computer terminal 100 in response to the request, generates an online authentication code Ocode and a mobile authentication code Mcode, provides the online authentication code Ocode to the computer terminal 100, provides the mobile authentication code Mcode to the portable terminal 200, obtains a mobile authentication code Mcode* received from the computer terminal 100, obtains an online authentication code Ocode* received from the portable terminal 200, obtains portable terminal identification information Dev_no when received the online authentication code Ocode*, compares the obtained online authentication code Ocode* with the online authentication code Ocode generated by the authentication request and the obtained mobile authentication code Mcode* with the mobile authentication code Mcode generated by the authentication request to verify accordance therebetween, compares the obtained portable terminal identification information Dev_no with the portable terminal identification information Tel_no input from the computer terminal 100 to verify accordance therebetween, and transmits an authentication result according to the verifications to the computer terminal 100.

The PG server 400 may be a payment gateway server or a value added network (VAN) system server and, when a payment settlement service configured to need authentication in the user's computer terminal 100 is performed, requests the authentication to the authentication server through a wired/wireless data communication network 250. When the authentication succeeds, a payment settlement process is performed, and a result thereof is provided to the computer terminal 100.

The service server 500 may be an information provision server configured to provide information, a financial server configured to provide an Internet banking service such as an account transfer, etc., or a web server of an online shopping-mall web site and, when a service configured to need authentication in the user's computer terminal 100 is performed, requests the authentication to the authentication server 300. When the authentication succeeds, a corresponding service is provided to the computer terminal 100.

Here, A* refers to information of a case in which information A (e.g., an online authentication code and a mobile authentication code) is transmitted and provided from an authentication server to one device, input back from the other device.

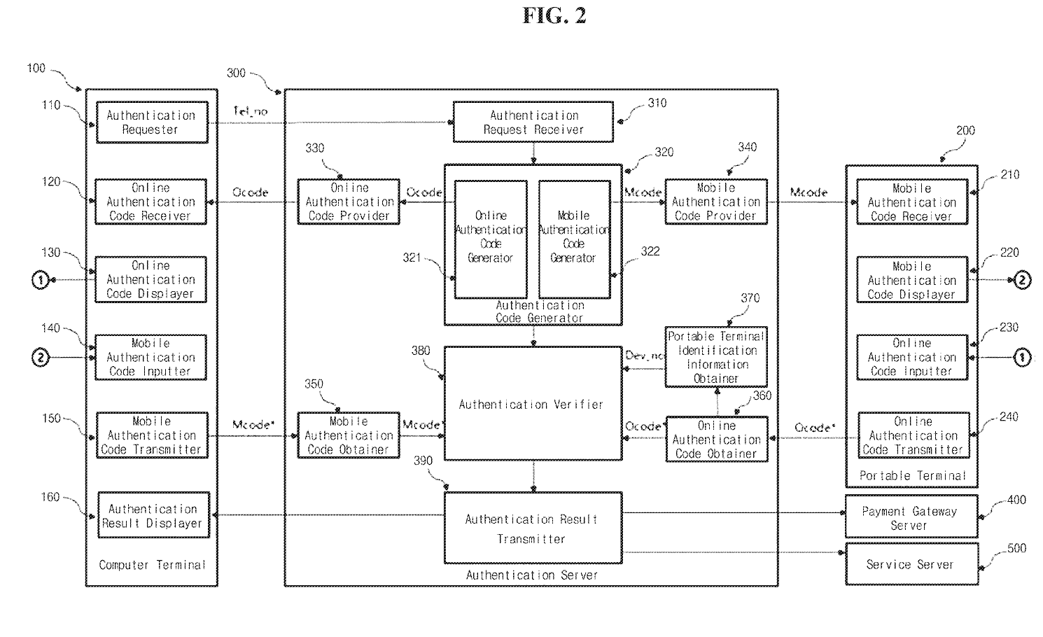

FIG. 2 is a view illustrating a detailed configuration of the mobile cross-authentication system according to the present invention. Hereinafter, a detailed configuration and operation of the mobile cross-authentication system will be described with reference to FIG. 2.

A configuration and operation of the computer terminal 100 will be described in detail. The computer terminal 100 includes an authentication requester 110, an online authentication code receiver 120, an online authentication code displayer 130, a mobile authentication code inputter 140, a mobile authentication code transmitter 150, and an authentication result displayer 160.

When an arbitrary service configured to need online authentication is used, the authentication requester 110 transmits a signal of an authentication request to the authentication server 300, receives a request of portable terminal identification information from the authentication server 300, and transmits user's portable terminal identification information Tel_no to the authentication server 300.

The online authentication code receiver 120 receives an online authentication code Ocode generated by the authentication server 300, and the online authentication code displayer 130 displays the online authentication code Ocode received from the authentication server 300 on a screen of the computer terminal 100.

The mobile authentication code inputter 140 inputs a mobile authentication code Mcode, which is generated by the authentication server 300 and transmitted to the portable terminal 200, into the computer terminal 100, and the mobile authentication code transmitter 150 transmits the input mobile authentication code Mcode to the authentication server 300.

The authentication result displayer 160 performs verification in the authentication server 300, receives an authentication result according to the verification, and displays the authentication result thereon.

A configuration and operation of the portable terminal 200 will be described in detail. The portable terminal 200 includes a mobile authentication code receiver 210, a mobile authentication code displayer 220, an online authentication code inputter 230, and an online authentication code transmitter 240.

The mobile authentication code receiver 210 receives the mobile authentication code Mcode generated by the authentication server 300, and the mobile authentication code displayer 220 displays the mobile authentication code Mcode received from the authentication server 300 on a screen of the portable terminal 200.

The online authentication code inputter 230 inputs the online authentication code Ocode, which is generated by the authentication server 300 and transmitted to the computer terminal 100, into the portable terminal 200, and the online authentication code transmitter 240 transmits the input online authentication code Ocode to the authentication server 300.

A configuration and operation of the authentication server 300 will be described in detail. The authentication server 300 includes an authentication request receiver 310, an authentication code generator 320, an online authentication code provider 330, a mobile authentication code provider 340, a mobile authentication code obtainer 350, an online authentication code obtainer 360, a portable terminal identification information obtainer 370, an authentication verifier 380, and an authentication result transmitter 390.

The authentication request receiver 310 receives a signal of an authentication request from the computer terminal 100, requests user's portable terminal identification information to the computer terminal 100, and receives user's portable terminal identification information Tel_no from the computer terminal 100.

The authentication code generator 320 includes an online authentication code generator 321 and a mobile authentication code generator 322, wherein the online authentication code generator 321 generates the online authentication code Ocode by the authentication request and mobile authentication code generator 322 generates the mobile authentication code Mcode by the authentication request.

The online authentication code provider 330 provides the online authentication code Ocode generated by the authentication code generator to the computer terminal 100, and the mobile authentication code provider 340 provides the mobile authentication code Mcode generated by the authentication code generator to the portable terminal 200.

The mobile authentication code obtainer 350 obtains the mobile authentication code Mcode* received from the computer terminal 100, the online authentication code obtainer 360 obtains the online authentication code Ocode* received from the portable terminal 200, and the portable terminal identification information obtainer 370 detects and obtains the portable terminal identification information Dev_no when received the online authentication code Ocode*.

The authentication verifier 380 compares the obtained online authentication code Ocode* with the online authentication code Ocode generated by the authentication code generator 320 and the obtained mobile authentication code Mcode* with the mobile authentication code Mcode generated by the authentication code generator 320 to verify accordance therebetween, and compares the obtained portable terminal identification information Dev_no with the portable terminal identification information Tel_no received by the authentication request receiver 310 from the computer terminal to verify accordance therebetween. An authentication result according to the verifications is determined as authentication success when all the verifications succeed and is determined as authentication fail even when one of the verifications fails.

The authentication result transmitter 390 transmits the authentication result according to the verifications from the authentication verifier 380 to the computer terminal 100.

A configuration of an authentication system according to a second embodiment of the present invention further includes a PG server 400 when a service configured to need payment settlement authentication is used, the computer terminal 100 requests payment settlement to the PG server 400, and authentication is requested to the authentication request receiver 310 of the authentication server 300 through the PG server 400. In addition, the authentication server performs verification and transmits an authentication result to the PG server 400.

When services for login, an account transfer, and an online shopping mall are used, a configuration of an authentication system according to a third embodiment of the present invention includes a service server 500 configured to provide corresponding services, the computer terminal 100 requests performing a service to the service server 500, and authentication is requested to the authentication request receiver 310 of the authentication server 300 through the service server 500. In addition, the authentication server performs verification, and an authentication result of the verification is transmitted to the service server 500.

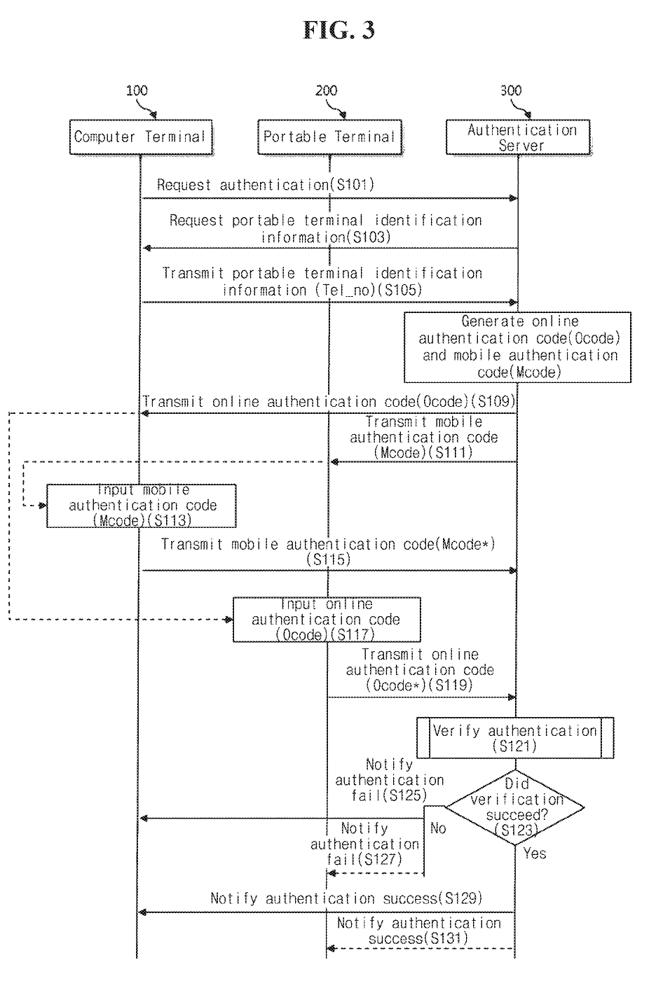

FIG. 3 is a procedure flowchart illustrating a mobile cross-authentication method according to a first embodiment of the present invention.

Referring to FIG. 3, when an arbitrary service configured to need online authentication is used, the computer terminal 100 transmits a signal of an authentication request to the authentication server 300 to request authentication (S101).

The authentication server 300 receives the signal of the authentication request from the computer terminal 100 and requests user's portable terminal identification information to the computer terminal 100 (S103).

The computer terminal 100 transmits user's portable terminal identification information Tel_no by the request of the portable terminal identification information to the authentication server 300 (S105).

The authentication server 300 generates an online authentication code Ocode and a mobile authentication code Mcode (S107).

The authentication server 300 transmits the generated online authentication code Ocode to the computer terminal 100 (S109).

The authentication server 300 transmits the generated mobile authentication code Mcode to the portable terminal 200 (S111).

The computer terminal 100 inputs the mobile authentication code Mcode displayed on the portable terminal 200 into the computer terminal 100 (S113) and transmits the input mobile authentication code Mcode to the authentication server 300 (S115).

The portable terminal 200 inputs the online authentication code Ocode displayed on the computer terminal 100 into the portable terminal 200 (S117) and transmits the input online authentication code Ocode* to the authentication server 300 (S119).

The authentication server 300 compares the generated online authentication code Ocode with the online authentication code Ocode* received from the portable terminal 200 to verify accordance therebetween, compares the generated mobile authentication code Mcode with the mobile authentication code Mcode* received from the computer terminal 100 to verify accordance therebetween, and compares the portable terminal identification information Tel_no input from the computer terminal 100 with portable terminal identification information Dev_no detected and obtained when received the online authentication code Ocode* to verify accordance therebetween (S121).

When all the three verifications succeed, the authentication server 300 determines an authentication result according to the verifications as authentication success and determines the authentication result as authentication fail even when one of the three verifications fails (S123).

When the authentication result according to the verifications is authentication fail, the authentication server 300 notifies the computer terminal 100 of the authentication fail (S125). At this time, the authentication server 300 may also notify the portable terminal 200 of the authentication fail (S127).

When the authentication result according to the verifications is authentication success, the authentication server 300 notifies the computer terminal 100 of the authentication success (S129). At this time, the authentication server 300 may also notify the portable terminal 200 of the authentication success (S131).

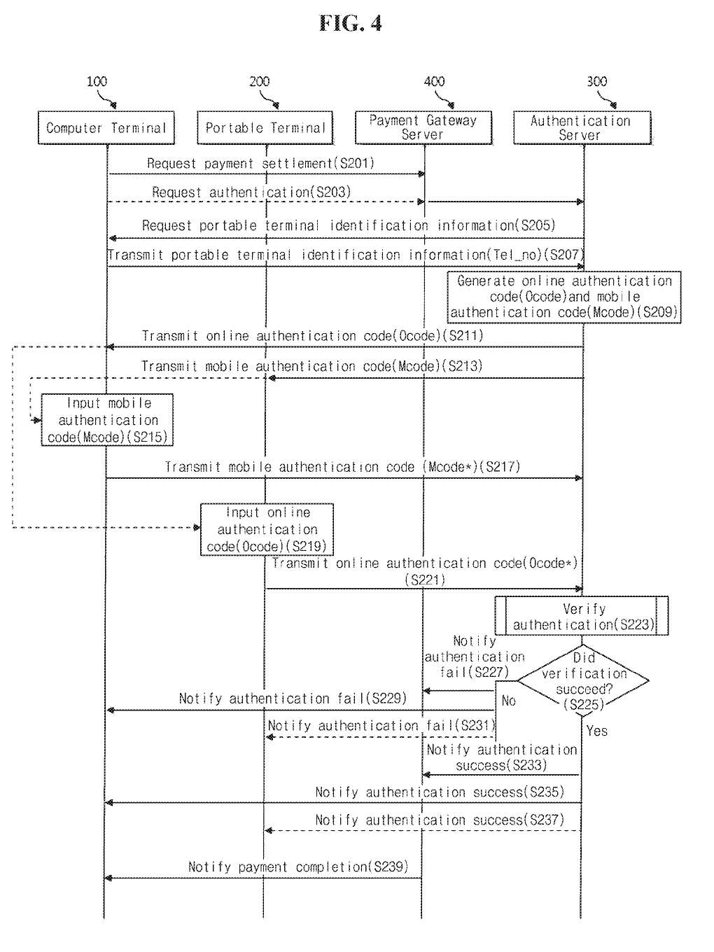

FIG. 4 is a procedure flowchart illustrating a mobile cross-authentication method according to second embodiment of the present invention.

Referring to FIG. 4, when an arbitrary service configured to need online payment settlement is used, the computer terminal 100 transmits a signal of a payment settlement request to the PG server 400 (S201) and requests authentication by transmitting a signal of an authentication request to the authentication server 300 through the PG server 400 (S203).

The authentication server 300 receives the signal of the authentication request from the computer terminal 100 through the PG server 400 and requests user's portable terminal identification information to the computer terminal 100 (S205).

The computer terminal 100 transmits user's portable terminal identification information Tel_no to the authentication server 300 by the request of the portable terminal identification information (S207).

The authentication server 300 generates an online authentication code Ocode and a mobile authentication code Mcode (S209).

The authentication server 300 transmits the generated online authentication code Ocode to the computer terminal 100 (S211).

The authentication server 300 transmits the generated mobile authentication code Mcode to the portable terminal 200 (S213).

The computer terminal 100 inputs the mobile authentication code Mcode displayed on the portable terminal 200 into the computer terminal 100 (S215) and transmits the input mobile authentication code Mcode* to the authentication server 300 (S217).

The portable terminal 200 inputs the online authentication code Ocode displayed on the computer terminal 100 into the portable terminal 200 (S219) and transmits the input online authentication code Ocode* to the authentication server 300 (S221).

The authentication server 300 compares the generated online authentication code Ocode with the online authentication code Ocode* received from the portable terminal 200 to verify accordance therebetween, compares the generated mobile authentication code Mcode with the mobile authentication code Mcode* received from the computer terminal 100 to verify accordance therebetween, and compares the portable terminal identification information Tel_no input from the computer terminal 100 with the portable terminal identification information Dev_no detected and obtained when received the online authentication code Ocode* to verify accordance therebetween (S223).

The authentication server 300 determines an authentication result according to the verifications as authentication success when all the three verifications succeed and determines the authentication result as authentication fail even when one of the three verifications fails (S225).

When the authentication result according to the verifications is authentication fail, the authentication server 300 notifies the PG server 400 of the authentication fail (S227) and also notifies the computer terminal 100 of the authentication fail (S229). At this time, the authentication server 300 may also notify the portable terminal 200 of the authentication fail (S231).

When the authentication result according to the verifications is authentication success, the authentication server 300 notifies the PG server 400 of the authentication success (S233) and also notifies the computer terminal 100 of the authentication success (S235). At this tithe, the authentication server 300 may also notify the portable terminal 200 of the authentication success (S237).

When the authentication result according to the verifications is the authentication success, the PG server 400 performs payment settlement and notifies the computer terminal 100 of completion of the payment settlement (S239).

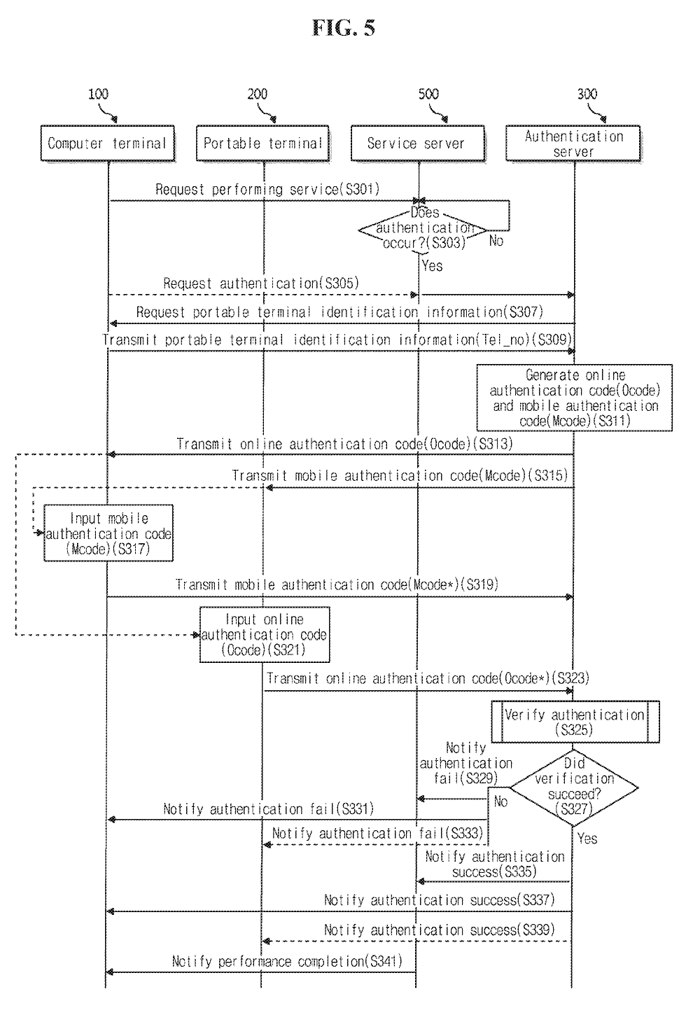

FIG. 5 is a procedure flowchart illustrating a mobile cross-authentication method according to a third embodiment of the present invention.

Referring to FIG. 5, when services for login, an account transfer, and an online shopping mall are used, the computer terminal 100 requests performing a service to the service server 500 (S301).

The service server 500 determines whether the corresponding services need authentication (S303).

When the corresponding services need authentication, the service server 500 requests the authentication by transmitting a signal of an authentication request from the computer terminal 100 to the authentication server 300 through the service server 500 (S305).

The authentication server 300 receives the signal of the authentication request from the computer terminal through the service server 500 and requests user's portable terminal identification information to the computer terminal 100 (S307).

The computer terminal 100 transmits user's portable terminal identification information Tel_no to the authentication server 300 by the request of the portable terminal identification information (S309).

The authentication server 300 generates an online authentication code Ocode and a mobile authentication code Mcode (S311).

The authentication server 300 transmits the generated online authentication code Ocode to the computer terminal 100 (S313).

The authentication server 300 transmits the generated mobile authentication code Mcode to the portable terminal 200 (S315).

The computer terminal 100 inputs the mobile authentication code Mcode displayed on the portable terminal 200 into the computer terminal 100 (S317) and transmits the input mobile authentication code Mcode* to the authentication server 300 (S319).

The portable terminal 200 inputs the online authentication code Ocode displayed on the computer terminal 100 into the portable terminal 200 (S321) and transmits the input online authentication code Ocode* to the authentication server 300 (S323).

The authentication server 300 compares the generated online authentication code Ocode with the online authentication code Ocode* received from the portable terminal 200 to verify accordance therebetween, compares the generated mobile authentication code Mcode with the mobile authentication code Mcode* received from the computer terminal 100 to verify accordance therebetween, and compares the portable terminal identification information Tel_no input from the computer terminal 100 with the portable terminal identification information Dev_no detected and obtained when received the online authentication code Ocode* to verify accordance therebetween (S325).

The authentication server 300 determines an authentication result according to the verification as authentication success when all the three verifications succeed and determines the authentication result as authentication fail even when one of the three verifications fails (S327).

When the authentication result according to the verifications is authentication fail, the authentication server 300 notifies the service server 500 of the authentication fail (S329) and also notifies the computer terminal 100 of the authentication fail (S331). At this time, the authentication server 300 may also notify the portable terminal 200 of the authentication fail (S333).

When the authentication result according to the verifications is authentication success, the authentication server 300 notifies the service server 500 of the authentication success (S335) and also notifies the computer terminal 100 of the authentication success (S337). At this time, the authentication server 300 may also notify the portable terminal 200 of the authentication success (S339).

When the authentication result according to the verifications is the authentication success, the service server 500 performs a corresponding service and notifies the computer terminal 100 of performance completion of the corresponding service (S341).

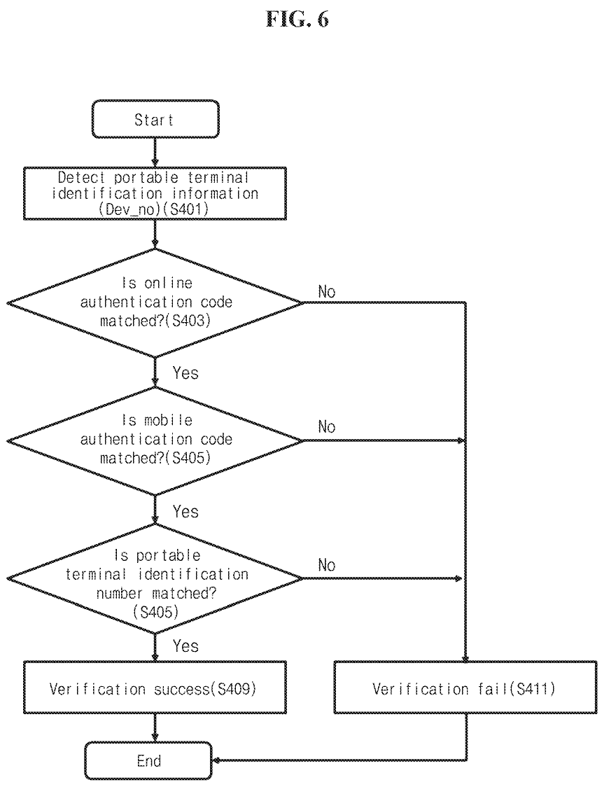

FIG. 6 is a flowchart illustrating an authentication verification method in an authentication server to which the mobile cross-authentication method according to the present invention is applied.

Referring to FIG. 6, when an online authentication code Ocode* is received from the online authentication code obtainer 360, the portable terminal identification information obtainer 370 obtains portable terminal identification information Dev_no (S401).

When the portable terminal identification information Dev_no is obtained, the authentication verifier 380 compares the online authentication code Ocode* obtained from the online authentication code obtainer 360 with an online authentication code Ocode generated by the authentication code generator 320 to verify accordance therebetween (S403).

When the verification succeeds, the authentication verifier 380 compares a mobile authentication code Mcode* obtained from the mobile authentication code obtainer 350 with a mobile authentication code Mcode generated by the authentication code generator 320 to verify accordance therebetween (S405).

When the verification succeeds, the authentication verifier 380 compares portable terminal identification information Dev_no obtained from the portable terminal identification information obtainer 370 with portable terminal identification information Tel_no received by the authentication request receiver 310 to verify accordance therebetween (S407).

The authentication verifier 380 determines authentication as verification success when all the three verifications succeed (S409) and determines the authentication as verification fail even when one of the three verifications fails (S411).

Meanwhile, the present invention is not limited to the above-described exemplary embodiments and it may be easily understood by those skilled in the art that various modifications, changes, substitutions or additions may be made without departing from the spirit and scope of the invention. When the practice of such modifications, changes, substitutions or additions are within the scope of the appended claims, the technical idea should also be regarded as belonging to the present invention.

1. A mobile cross-authentication system comprising:
a computer terminal which transmits a signal of an authentication request to a authentication server when using an arbitrary service configured to need online authentication, transmits and inputs user's portable terminal identification information (Tel_no) into the authentication server when the authentication server requests the user's portable terminal identification information, receives an online authentication code (Ocode) generated in the authentication server by the authentication request, displays the online authentication code (Ocode) thereon, receives a mobile authentication code (Mcode) which is generated in the authentication server by the authentication request and received from the portable terminal, transmits the mobile authentication code (Mcode) to the authentication server, and displays an authentication result received from the authentication server thereon;
a portable terminal which receives the mobile authentication code (Mcode) generated in the authentication server by the authentication request, displays the mobile authentication code (Mcode) thereon, and receives the online authentication code (Ocode) displayed on the computer terminal to transmit the online authentication code (Ocode) to the authentication server; and
an authentication server which receives the signal of the authentication request from the computer terminal, requests the user's portable terminal identification information to the computer terminal, receives the portable terminal identification information (Tel_no) input from the computer terminal in response to the request, generates the online authentication code (Ocode) and the mobile authentication code (Mcode) which are respectively provided to the computer terminal and the portable terminal, obtains a mobile authentication code (Mcode*) input and received from the computer terminal, obtains an online authentication code (Ocode*) input and received from the portable terminal, obtains a portable terminal identification information (Dev_no) when received the online authentication code (Ocode*), compares the obtained online authentication code (Ocode*) with the online authentication code (Ocode) generated by the authentication request and the obtained mobile authentication code (Mcode*) with the mobile authentication code (Mcode) generated by the authentication request to verify accordance therebetween, compares the obtained portable terminal identification information (Dev_no) with the portable terminal identification information (Tel_no) input from the computer terminal to verify accordance therebetween, and transmits an authentication result according to the verifications to the computer terminal.

2. The mobile cross-authentication system of claim 1, wherein the authentication server includes:
an authentication request receiver which receives the signal of the authentication request from the computer terminal, requests the user's portable terminal identification information to the computer terminal, and receives the portable terminal identification information (Tel_no) input from the computer terminal in response to the request;
an authentication code generator which generates the online authentication code (Ocode) and the mobile authentication code (Mcode) by the authentication request;
an online authentication code provider which provides the online authentication code (Ocode) generated by the authentication code generator to the computer terminal;
a mobile authentication code provider which provides the mobile authentication code (Mcode) generated by the authentication code generator to the portable terminal;
a mobile authentication code obtainer which obtains a mobile authentication code (Mcode*) received from the computer terminal by being input into the compute terminal the mobile authentication code (Mcode) displayed on the portable terminal;
an online authentication code obtainer which obtains an online authentication code (Ocode*) received from the portable terminal by being input the online authentication code (Ocode) displayed on the computer terminal into the portable terminal;
a portable terminal identification information obtainer which detects and obtains the portable terminal identification information (Dev_no) when received the online authentication code (Ocode*);
an authentication verifier which compares the obtained online authentication code (Ocode*) with the online authentication code (Ocode) generated by the authentication code generator and the obtained mobile authentication code (Mcode*) with the mobile authentication code (Mcode) generated by the authentication code generator to verify accordance therebetween, and compares the obtained portable terminal identification information (Dev_no) with the portable terminal identification information (Tel_no) input from the computer terminal to verify accordance therebetween; and
an authentication result transmitter which transmits an authentication result according to the verifications to the computer terminal.

3. The mobile cross-authentication system of claim 2, wherein the authentication verifier compares the online authentication code (Ocode) generated by the authentication request with the online authentication code (Ocode*) received from the portable terminal to verify accordance therebetween, compares the mobile authentication code (Mcode) generated by the authentication request with the mobile authentication code (Mcode*) received from the computer terminal to verify accordance therebetween, and compares the portable terminal identification information (Tel_no) input from the computer terminal with the portable terminal identification information (Dev_no) detected and obtained when received the online authentication code (Ocode*) to verify accordance therebetween, and a result according to the authentication request is determined as authentication success when all the three verifications succeed and is determined as authentication fail even when one of the three verifications fails.

4. The mobile cross-authentication system of claim 1, wherein the computer terminal includes:
an authentication requester which transmits the signal of the authentication request to the authentication server and transmits the portable terminal identification information (Tel_no) to the authentication server by the request of the portable terminal identification information;
an online authentication code receiver which receives the online authentication code (Ocode) generated in the authentication server by the authentication request;
an online authentication code displayer which displays the online authentication code (Ocode) received from the authentication server on a screen of the computer terminal;
an mobile authentication code inputter which inputs the mobile authentication code (Mcode), which is generated in the authentication server by the authentication request and received from the portable terminal, into the computer terminal;
a mobile authentication code transmitter which transmits the input mobile authentication code (Mcode) to the authentication server; and
an authentication result displayer which displays an authentication result received from the authentication server after the authentication server performs verification.

5. The mobile cross-authentication system of claim 1, wherein the portable terminal includes:
a mobile authentication code receiver which receives the mobile authentication code (Mcode) generated in the authentication server by the authentication request;
a mobile authentication code displayer which displays the mobile authentication code (Mcode) received from the authentication server on a screen of the portable terminal;
an online authentication code inputter which inputs the online authentication code (Ocode) displayed on the computer terminal into the portable terminal; and
an online authentication code transmitter which transmits the input online authentication code (Ocode) to the authentication server.

6. The mobile cross-authentication system of claim 5, wherein the portable terminal receives a message including the mobile authentication code (Mcode) generated by the authentication server, receives the online authentication code (Ocode) displayed on the computer terminal, forms a message, and transmits the formed message to the authentication server, and the formed message is formed as one of mobile communication messages, such as a short message service (SMS) message, a long message service (LMS) message, and a multimedia message service (MMS) message, and smart phone push messages.

7. The mobile cross-authentication system of claim 1, wherein the online authentication code (Ocode) and the mobile authentication code (Mcode) are generated as one-time random authentication codes and deleted when the online authentication code (Ocode) and the mobile authentication code (Mcode) are unused within a predetermined period from a generated time point thereof.

8. A mobile cross-authentication method comprising:
an authentication request process in which a computer terminal transmits a signal of an authentication request to an authentication server when using an arbitrary service configured to need online authentication, receives a request of user's portable terminal identification information from the authentication server, and transmits a user's portable terminal identification information (Tel_no) to the authentication server in response to the request;
an authentication code generation process in which the authentication server generates an online authentication code (Ocode) and a mobile authentication code (Mcode) by the authentication request;
an authentication code provision process in which the authentication server provides the online authentication code (Ocode) generated by the authentication request to the computer terminal and provides the mobile authentication code (Mcode) generated by the authentication request to the portable terminal;
an authentication code display process in which the computer terminal displays the online authentication code (Ocode) received from the authentication server on a screen of the computer terminal, and the portable terminal displays the mobile authentication code (Mcode) received from the authentication server on a screen of the portable terminal;
an authentication code cross-transmission process in which the computer terminal receives the mobile authentication code (Mcode) displayed on the portable terminal and transmits the mobile authentication code (Mcode) to the authentication server, and the portable terminal receives the online authentication code (Ocode) displayed on the computer terminal and transmits the online authentication code (Ocode) to the authentication server; and
an authentication verification process in which the authentication server obtains a mobile authentication code (Mcode*) received from the computer terminal, obtains an online authentication code (Ocode*) received from the portable terminal, detects and obtains a portable terminal identification information (Dev_no) when received the online authentication code (Ocode*), compares the obtained online authentication code (Ocode*) with the online authentication code (Ocode) generated by the authentication request and the obtained mobile authentication code (Mcode*) with the mobile authentication code (Mcode) generated by the authentication request to verify accordance therebetween, compares the obtained portable terminal identification information (Dev_no) with the portable terminal identification information (Tel_no) input from the computer terminal to verify accordance therebetween, and transmits an authentication result according to the verifications to the computer terminal.

9. The mobile cross-authentication method of claim 8, wherein the authentication code generation process includes:
an online authentication code generation process in which the authentication server generates the online authentication code (Ocode); and
a mobile authentication code generation process in which the authentication server generates the mobile authentication code (Mcode).

10. The mobile cross-authentication method of claim 8, wherein the authentication code provision process includes:
an online authentication code provision process in which the authentication server provides the online authentication code (Ocode) generated during the authentication code generation process to the computer terminal; and
a mobile authentication code provision process in which the authentication server provides the mobile authentication code (Mcode) generated during the authentication code generation process to the portable terminal.

11. The mobile cross-authentication method of claim 8, wherein the authentication code display process includes:
an online authentication code display process in which the computer terminal displays the online authentication code (Ocode) received from the authentication server on the screen of the computer terminal; and
a mobile authentication code display process in which the portable terminal displays the mobile authentication code (Mcode) received from the authentication server to the screen of the portable terminal.

12. The mobile cross-authentication method of claim 8, wherein the authentication code cross-transmission process includes:
an online authentication code transmission process in which the portable terminal receives the online authentication code (Ocode) displayed on the computer terminal and transmits the online authentication code (Ocode) to the authentication server; and
a mobile authentication code transmission process in which the computer terminal receives the mobile authentication code (Mcode) displayed on the portable terminal and transmits the mobile authentication code (Mcode) to the authentication server.

13. The mobile cross-authentication method of claim 8, wherein the authentication verification process includes:
a portable terminal identification information obtainment process which detects and obtains the portable terminal identification information (Dev_no) when received the online authentication code (Ocode*) from the portable terminal;
a verification performance process which compares the obtained online authentication code (Ocode*) with the online authentication code (Ocode) generated by the authentication request and the obtained mobile authentication code (Mcode*) with the mobile authentication code (Mcode) generated by the authentication request to verify accordance therebetween and compares the obtained portable terminal identification information (Dev_no) with the portable terminal identification information (Tel_no) input from the computer terminal to verify accordance therebetween; and
an authentication result notification process which transmits an authentication result according to the verification to the computer terminal.
